(19) United States
(12) Patent Application Publication
(10) Pub. No.: US 2017/0003749 A1
(43) Pub. Date: Jan. 5, 2017

(54) METHOD OF HAND-GESTURE INPUT

(71) Applicant: International Business Machines Corporation, Armonk, NY (US)

(72) Inventors: Debbie A. ANGLIN, Austin, TX (US); Su LIU, Austin, TX (US); Cheng XU, Beijing (CN); Quan W. ZHANG, Beijing (CN)

(21) Appl. No.: 14/833,486

(22) Filed: Aug. 24, 2015

Related U.S. Application Data
(63) Continuation of application No. 14/788,041, filed on Jun. 30, 2015.

(51) Int. Cl. G06F 3/01; G06F 3/0482; G06T 11/60

(52) U.S. Cl. CPC G06F 3/017; G06T 11/60; G06F 3/0482

(57) ABSTRACT

The present disclosure provides a method for efficiently providing character-based languages (e.g., Chinese, Japanese, and/or Korean) into portable electronic devices (e.g., smartphones, smartwatches, smartglasses, etc.). An example method generally includes receiving a sequence of hand-gesture inputs from an input device, detecting a pattern corresponding to each hand-gesture input in the sequence, determining a sequence of numeric values that correspond to the sequence of hand-gesture inputs based on the detected patterns, and, as each input in the sequence of hand-gesture inputs is received, determining a list of one or more characters to display based, at least in part, on the sequence of numeric values and an index of characters.

### CROSS-REFERENCE TO RELATED APPLICATIONS

This application is a continuation of co-pending U.S. patent application Ser. No. 14/788,041 filed Jun. 30, 2015. The aforementioned related patent application is herein incorporated by reference in its entirety.

### BACKGROUND

The present invention generally relates to an input method for electronic devices, and more specifically, to an input method for character-based languages for wearable smart devices.

Recently, there has been a significant interest in wearable smart devices such as glasses-type and wristwatch-type portable devices. In most wearable devices, however, traditional input devices (e.g., a keyboard, touchscreen, etc.) are either not provided or may not be used efficiently, especially when trying to input characters of character-based languages. For example, due to the sheer number of characters in these languages (e.g., over 10,000 CJK characters) and the fine detail required to draw these characters, it difficult to provide input on small touch screen devices, like those typically provided on wearable smart devices. Some touchless input methods such as audio input exist, but the efficiency and accuracy of such input methods serve as bottlenecks, especially for inputting a large number of characters, such as Chinese, Japanese, and Korean (CJK) graphic characters.

### SUMMARY

One embodiment of the present invention includes a method of generating input for an electronic device corresponding to characters. The method generally includes receiving a sequence of hand-gesture inputs from an input device, detecting a pattern corresponding to each hand-gesture input in the sequence, determining a sequence of numeric values that correspond to the sequence of hand-gesture inputs based on the detected patterns, and, as each input in the sequence of hand-gesture inputs is received, determining a list of one or more characters to display based, at least in part, on the sequence of numeric values and an index of characters.

### BRIEF DESCRIPTION OF THE SEVERAL VIEWS OF THE DRAWINGS

FIG. 1 illustrates an example computing environment, according to certain aspects of the present disclosure.

FIG. 2 illustrates a table mapping hand gestures to character strokes and numeric values, according to certain aspects of the present disclosure.

FIG. 3A-3C illustrate an example process for entering characters of a character-based language into a wearable smart device, according to certain aspects of the present disclosure.

FIGS. 4A and 4B illustrate an example process for entering characters of a character-based language into a wearable smart device, according to certain aspects of the present disclosure.

FIG. 5 illustrates an example method for enter characters of a character-based language into a wearable smart device, according to certain aspects of the present disclosure.

FIG. 6 illustrates an example computing system, according to certain aspects of the present disclosure.

### DETAILED DESCRIPTION

Embodiments presented herein describe techniques for efficiently providing character-based languages (e.g., Chinese, Japanese, Korean, etc.) into wearable smart devices (e.g., smartphones, smartwatches, smartglasses, etc.). As noted, there is has been significant interest in wearable smart devices such as glasses-type and wristwatch-type portable devices. In most wearable devices, however, traditional input devices (e.g., a keyboard, touchscreen, etc.) are either not provided or may not be used efficiently, especially when trying to input characters of character-based languages. For example, due to the sheer number of characters in these languages (e.g., over 10,000 CJK characters) and the fine detail required to draw these characters, it difficult to provide input on small touch screen devices, like those typically provided on wearable smart devices. Some touchless input methods such as audio input exist, but the efficiency and accuracy of such input methods serve as bottlenecks, especially for inputting a large number of characters, such as Chinese, Japanese, and Korean (CJK) graphic characters.

Traditionally, due to the complex nature and amount of characters (e.g., over 10,000 CJK characters), representing character-based languages electronically has been a challenge. Techniques have been developed to aid in handling character-based languages electronically. For example, one technique, known as the “four corner method”, involves encoding characters (e.g., Chinese characters) into either a computer or a manual typewriter, using four or five numerical digits per character, as explained in greater detail below. The four digits encode the shapes found in the four corners of the symbol, top-left to bottom-right in a “Z” pattern (i.e., top-left→top-right→bottom-left→bottom-right). Although this may not uniquely identify a specific CJK character, it can reduce the large character sets to only a very short list of possibilities. A fifth digit can be added to describe an extra part/shape above the bottom-right corner, if necessary.

Techniques have also been developed to bridge a gap between the many dialects of Chinese when representing numbers. For example, one technique, known as “Chinese number gestures,” which involve the use of one hand to signify the natural numbers zero through nine.

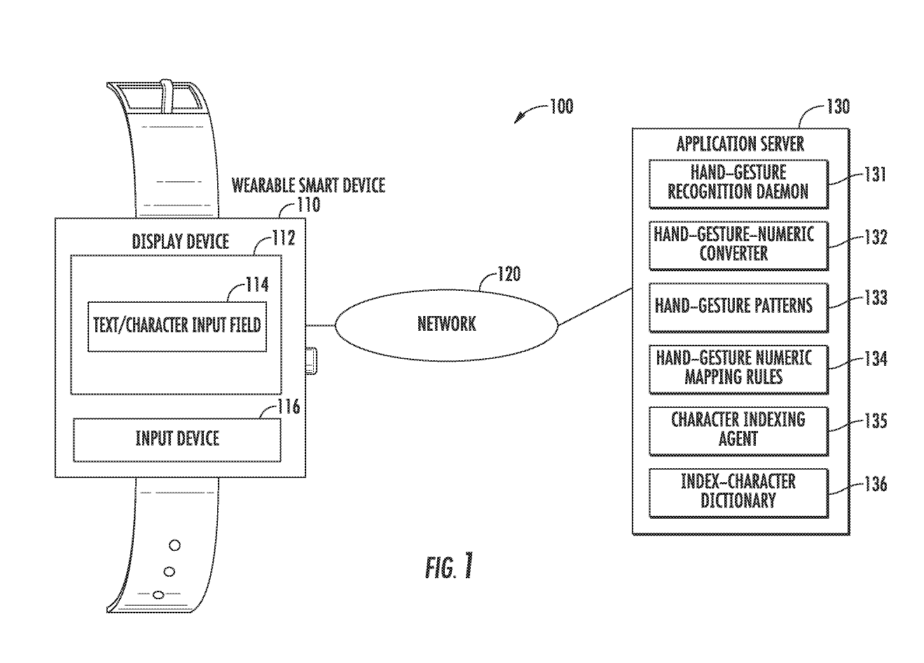

According to certain aspects, rather than having to try to compose fine character detail on a wearable smart device with a relatively small display, these hand gestures may be used to signify the four or five numerical digits used to encode CJK characters in the four corner method. For example, when entering characters of a character-based language (e.g. Chinese) into an electronic device (e.g., a wearable smart device), the hand gestures for signifying the natural numbers zero through nine may be used to indicate the sequence of digits used to encode the shapes found in the four corners, or regions (e.g., generally the top-left region, top-right region, bottom-left region, and bottom-right region), of a symbol. The sequence of digits may then be used to search an index of characters for characters matching the sequence of digits, as explained in greater detail below with references to FIGS. 1-5

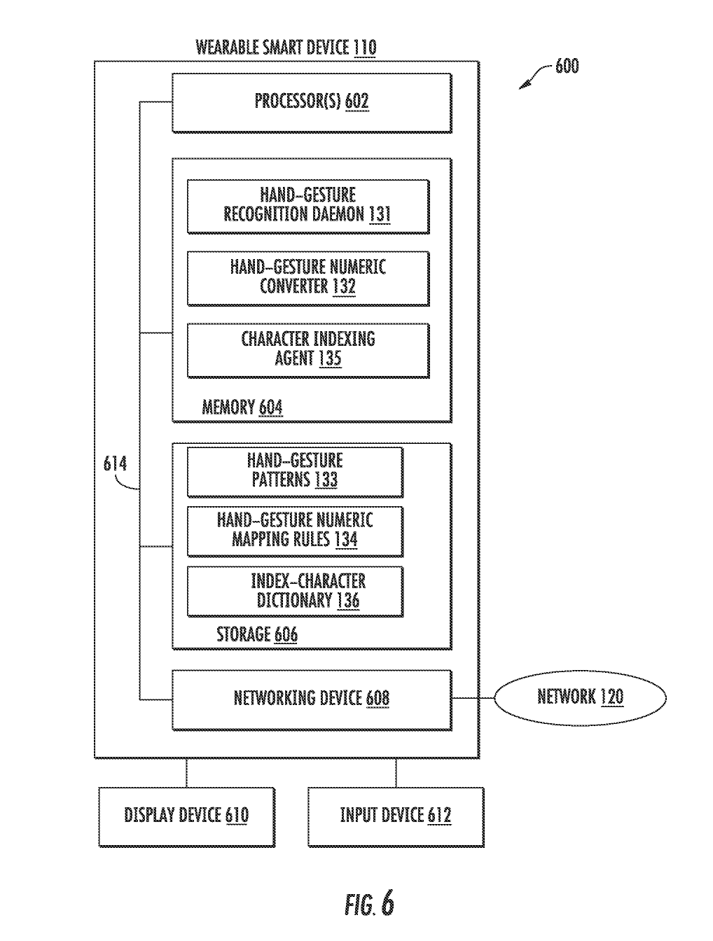

FIG. 1 illustrates an example computing environment 100 for efficiently inputting character-based languages. As shown, the computing environment 100 includes a wearable smart device 110, a data communications network 120, and an application server 130. As shown, the wearable smart device 110 and application server 130 may be interconnected via the data communications network 120. For example, the data communications network 140 may include the Internet as well as local area networks, etc. Further, although FIG. 1 illustrates multiple systems configured to communicate over a network, those skilled in the art will recognize that embodiments of the invention may be adapted for use on a single computer system, for example, as shown in FIG. 6.

According to certain aspects, the wearable smart device 110 may be a smartphone, a smartwatch, smartglasses, or any other computing device able to access the data communications network 120. Further, wearable smart device 110 may include an input device 116 for sensing hand-gestures. For example, the input device 116 may include a camera, a motion sensor, a bio-electronic sensor, or any other type of device capable of sensing and observing hand-gestures. The wearable smart device 110 also includes a display device 112 for displaying a text/character input field 114. According to certain aspects, the text/character input field 114 may be used (e.g., in conjunction with the input device 116) for inputting text or characters of a character-based language. For example, as described in more detail below, the input device 116 may be used to sense a sequence of hand gestures of a user. The sequence of hand gestures may then be correlated (e.g., by one or more components of the application server 130) to one or more CJK characters and the one or more CJK characters may then be displayed in the text/character input field 114.

As noted, the computing environment 100 includes an application server 130. The application server 130 includes a hand-gesture recognition daemon 131, a hand-gesture numeric converter 132, hand-gesture patterns 133, CJK radical-numeric mapping rules 134, a character indexing agent 135, and an index-character dictionary 136.

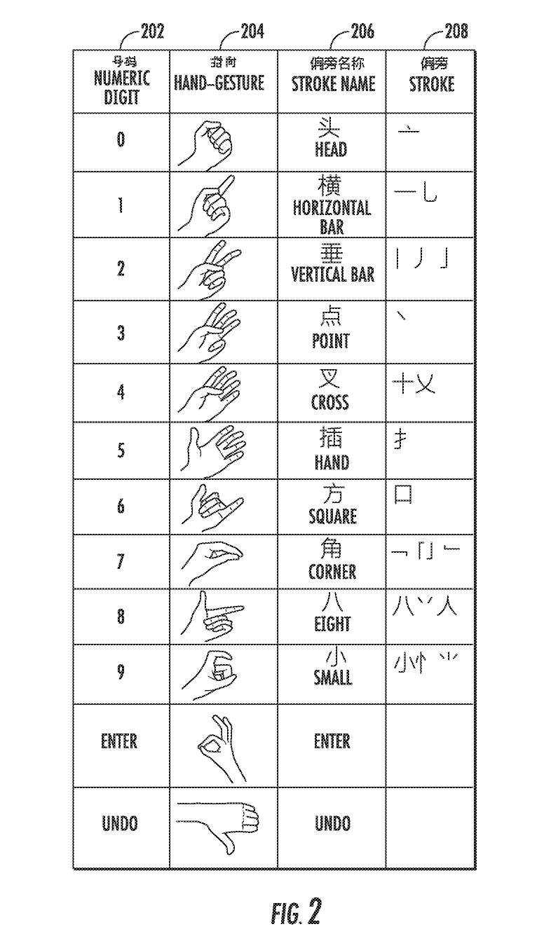

According to certain aspects, the application server 130 provides correlation/conversion services for hand gestures sensed by the input device 116 of the wearable smart device 110. For example, as explained in greater detail below, the input device 116 may sense a sequence of hand gestures and a pattern in each hand gesture of the sequence of hand gestures may then be recognized by a hand-gesture recognition daemon 131. According to certain aspects, based on the detected patterns, the sequence of hand gestures may be converted into a sequence of numeric values by a hand-gesture numeric converter 132 and the sequence of numeric values may be used to look up one or more CJK characters in an index of characters (e.g., the index-character dictionary 136). The text/character input field 114 may then display the CJK characters corresponding to the sequence of numeric values. This process is described in greater detail below with reference to FIGS. 2-5.

FIG. 2 illustrates a table mapping hand gestures to strokes and numeric values, according to certain aspects of the present disclosure. As noted above, techniques have been developed to bridge a gap between many dialects of Chinese when representing numbers. These techniques involve using certain hand gestures to signify the natural numbers zero through nine. For example, column 204 of the table shown in FIG. 2 illustrates ten different hand gestures which corresponding to numerical values zero through nine which are illustrated in column 202. Column 204 also shows two additional hand gestures (i.e., enter and undo) which may be used to control the input of characters. For example, the enter hand gesture may be used to select a particular character and/or to indicate that a user is finished entering hand gestures for a particular character. According to certain aspects, the undo hand gesture may be used to undo a previously entered hand gesture and/or to delete a previously selected character. While column 204 illustrates a specific set of hand gestures for indicating numeric values zero-nine and for controlling character input, it should be noted that any set of unique hand gestures may be used.

Also, as noted above, techniques (e.g., the “four corner method”) may be used be to represent characters (e.g., Chinese characters) using four or five numerical digits per character that encode the shapes found in the four corners of the character. For example, column 208 of the table shown in FIG. 2 illustrates various shapes that a corner of a character may be and column 206 lists the shapes' stroke name. According to certain aspects, the shapes illustrated in column 208 may correspond to both the hand gestures in column 204 and the numeric digits in column 202. For example, the stroke illustrated in first row of column 208 corresponds with the number zero and with the “fist” hand-gesture of the first row in column 204. Thus, according to certain aspects, a user of the wearable smart device 110 may use a sequence of hand gestures (e.g., those illustrated in column 204) to enter a sequence of numerical values that corresponds to the shapes in the four corners/regions of a character that the user desires to input, allowing the user to input a great number of characters on a small device using easy to use hand-gestures input a character (e.g., by using the four-corner method). A user may then be presented with a list of one or more characters matching the entered numerical sequence from which the user may make a selection, for example, by using the “enter” hand gesture illustrated in the last row of column 204.

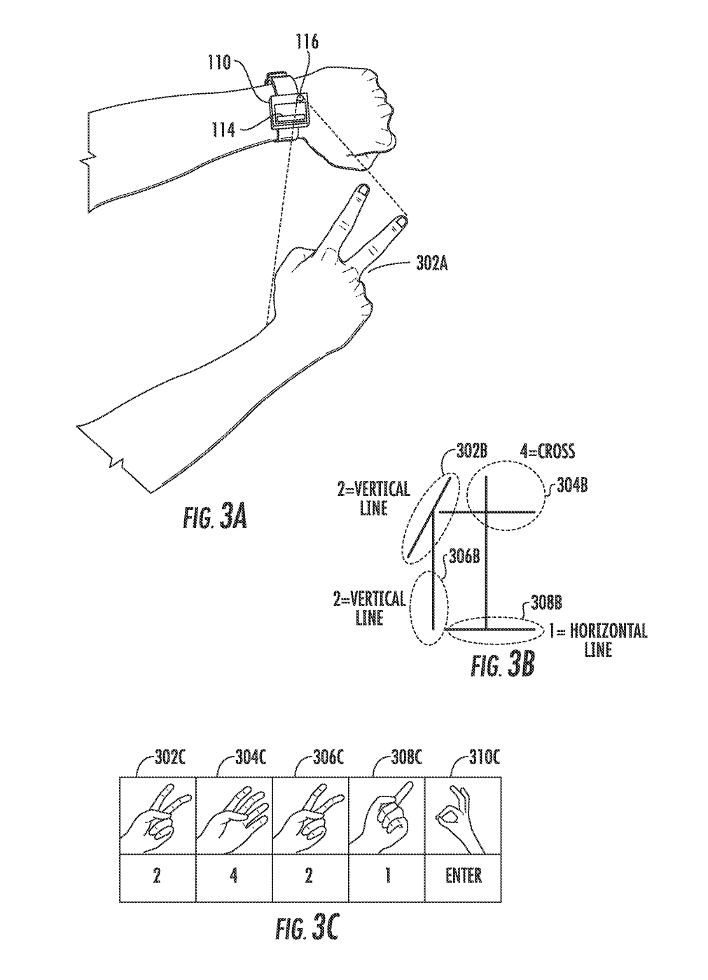

FIGS. 3A-3C illustrate an example process for entering CJK characters into a wearable smart device (e.g., wearable smart device 110). For example, as illustrated in FIG. 3A, a user wanting to input a CJK character (e.g., [symbol] ) into the text/character field 114 may perform the hand gesture for the number two. With reference to FIG. 3B, the hand gesture for the number two shown in FIG. 3A may correspond to the vertical bar stroke of the corner 302B (i.e., the top-left region) of the it character. The user may then perform hand gestures for the remaining three corners (i.e., corners/regions 304B, 306B, and 308B) to finish entry of the [symbol] character.

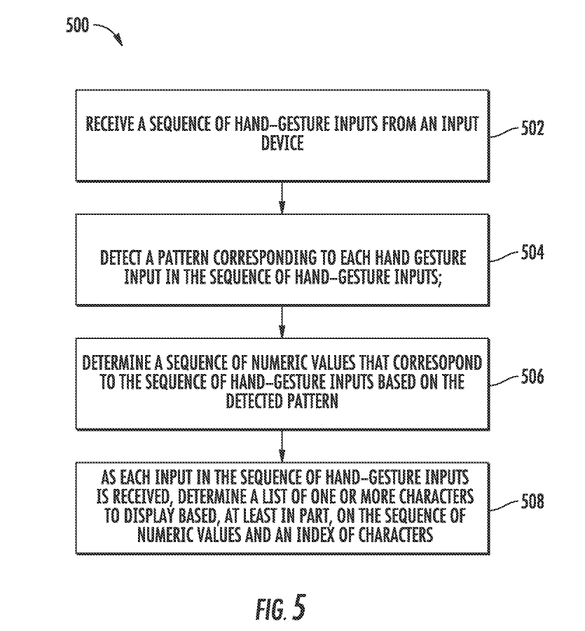

For example, as shown in FIG. 3C, in order to input the [symbol] character illustrated in FIG. 3B, the user may input at 302C the hand gesture for the number two which corresponds to the “vertical bar” shape (as referenced in the table illustrated in FIG. 2) of corner 302B (i.e., the top-left region). Next, the user may input at 304C the hand gesture for the number four which corresponds to the “cross” shape of corner 304B (i.e., the top-right region). Next, the user may input at 306C the hand gesture for the number two which corresponds to the “vertical bar” shape of corner 306B (i.e., the bottom-left region). The user may then input at 308C the hand gesture for the number one which corresponds to the “horizontal bar” shape of corner 308B (i.e., the bottom-right region). Finally, the user may indicate that hand-gesture input for the character is finished by presenting the hand gesture corresponding to “enter”. According to certain aspects, one or more characters (e.g., the [symbol] character) corresponding to the numeric sequence 2-4-2-1 may then be presented (e.g., on the display device 112) to the user for selection (e.g., by the user presenting the hand gesture corresponding to “enter”). As described in greater detail below with reference to FIGS. 5 and 6, the process of determining which character to present based on the hand gestures performed by a user include using the numerical sequence corresponding to the sequence of hand gestures as an index to look-up matching characters in an index of characters (e.g., the index-character dictionary 136).

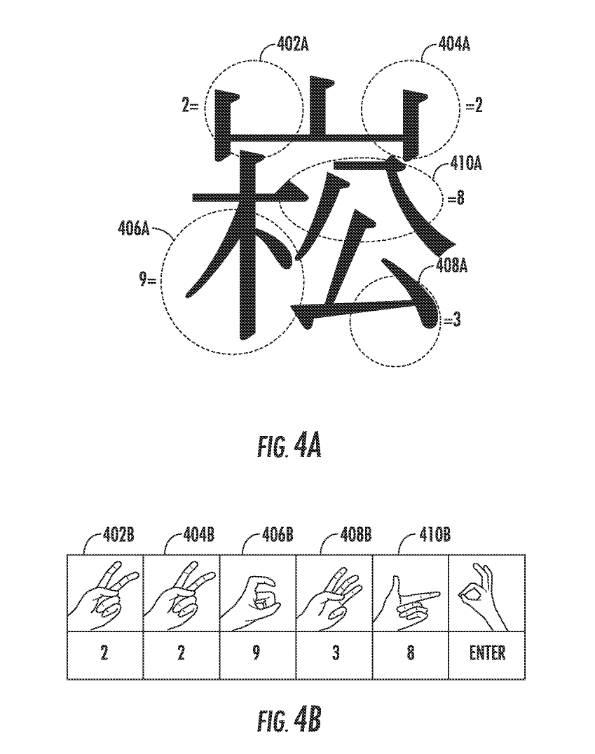

Inputting only the hand gestures for the four corners of a character may not uniquely identify the desired character. Thus, to provide more accuracy when looking up a character, a fifth digit/hand gesture can be added to describe an extra part/shape above the bottom-right corner. For example, FIG. 4B shows the user inputting a sequence of the hand gestures which includes 402B, 404B, 406B, and 408B for the shapes of the four corners (i.e., 402A, 404A, 406A, and 408A) of the character illustrated in 4A and may also enter a fifth hand gesture (i.e., 410B) for the shape appearing just above the fourth corner (i.e., 410A). After indicating that hand-gesture input is complete, the user may be presented with the character illustrated in FIG. 4A.

FIG. 5 illustrates a method 500 for efficiently providing characters of a character-based language into a wearable smart device, according to certain aspects of the present disclosure.

The method 500 begins at step 502 by receiving a sequence of hand-gesture inputs from an input device. For example, at step 502, a user of a wearable smart device (e.g., wearable smart device 110) may decide to input characters of a character-based language (e.g., CJK) into a text/character input field 114. To do so, the user may perform a sequence of hand gestures, as described above, observed by an input device 116 (e.g., a camera). In response, the wearable smart device 110 may transfer (e.g., via the network 120) the received sequence of hand gestures to an application server 130 for character recognition. Additionally, in some cases, the wearable smart device 110 may perform both the sensing of hand gestures and the recognizing of characters based on the sense hand gestures, as described below with reference to FIG. 6.

At step 504, the application server 130 may determine a pattern corresponding to each hand-gesture input of the sequence of hand gestures. For example, a hand-gesture recognition daemon 131 on the application server 130 may receive the sequence of hand gestures and determine a pattern matching each hand-gesture input, for example, based on a set of pre-defined hand-gesture patterns 133.

At step 506, a sequence of numeric values that correspond to the sequence of hand-gesture inputs is determined based on each detected pattern. For example, at step 506, the hand-gesture recognition daemon 131 may provide the recognized hand gesture patterns to the hand-gesture numeric converter 132 which generates a sequence of numeric values corresponding to the sequence of hand-gesture inputs. For example, the hand-gesture numeric converter 132 may the recognized hand-gesture patterns and, based on hand-gesture numeric mapping rules 134, may convert the hand-gesture patterns into a sequence of numeric values.

At step 508, as each input in the sequence of hand-gesture inputs is received, a list of one or more characters to display is determined based, at least in part, on the sequence of numeric values and an index of characters. For example, the character indexing agent 135 may receive the sequence of numeric values from the hand-gesture numeric converter 132 and may determine a list of one or more characters (e.g., CJK characters) to display based on the numeric sequence and an index of characters (e.g., a CJK dictionary), as explained in greater detail below.

For example, the index of characters may include a collection of characters indexed according to an index sequence that corresponds to different shapes (i.e., written strokes) appearing in the corners/regions of a character (e.g., according to the “four corner method” described above). Accordingly, the character indexing agent 135 may use the sequence of numeric values to search the index of characters for characters whose index sequence matches the numeric sequence corresponding to the inputted sequence of hand gestures. A list of matching characters may then be displayed to the user for selection. According to certain aspects, the user may select a character from the list by performing the hand gesture for “enter”, as illustrated in FIG. 2.

According to certain aspects, the list of matching characters may be populated on a per-hand gesture basis. For example, upon inputting a first hand gesture, the user may be presented with a list of all characters matching the first hand gesture. However, as the user continues to add hand gestures to the sequence of hand gestures, the list of matching characters may be continually refined/updated. For example, when a user inputs a first hand gesture, for example, corresponding to the number two, the list of matching characters will comprise all characters having a top-left corner encoded as the number two. As the user inputs a second hand gesture, for example, corresponding to the number three, the list of matching characters will be refined to only include those characters having a top-left corner encoded as the number two and a top-right corner encoded as the number three. The refining of the list may continue as the user performs each additional hand gesture.

FIG. 6 illustrates an example computing environment 600, according to an embodiment of the present invention. As shown, computing environment 600 includes wearable smart device 110. Wearable smart device 110 is included to be representative of existing computer systems, e.g., smartphones, smartwatches, smart glasses, and the like. However, embodiments of the invention are not limited to any particular computing system, application, device, or network architecture and instead, may be adapted to take advantage of new computing systems and platforms as they become available. Further, although FIG. 6 illustrates a single computer system, those skilled in the art will recognize that embodiments of the invention may be adapted for use on multiple systems configured to communicate over a network, for example, as shown in FIG. 1. Additionally, those skilled in the art will recognize that the illustration of wearable smart device 110 is simplified to highlight aspects of the present invention and that computing systems and data communication networks typically include a variety of additional elements not shown in FIG. 6.

As shown, wearable smart device 110 includes one or more processors 602, a memory 604, storage 606, and a networking device 608, all connected by a bus 614. Wearable smart device 110 may be connected to one or more display devices 610 and one or more input devices 612. Input devices 612 may include a camera, a motion sensor, a bio-electronic sensor, or any other type of device capable of sensing hand gestures. Display devices 610 may include CRT monitors, LCD displays, projectors, and the like. The processing activity and hardware resources on wearable smart device 110 may be managed by an operating system (not shown). Networking device 608 may connect wearable smart device 110 to a data communications network 120, including both wired and wireless networks. It should be understood, however, that while FIG. 6 illustrates a data communications 120, the wearable smart device 110 is capable of operation (i.e., is capable of performing the method(s) described herein) without using the data communications network 120.

Storage 606 may store application programs and data (e.g., hand-gesture patterns, hand-gesture numeric mapping rules, and/or an index-character dictionary) for use by wearable smart device 110. Typical storage devices include hard-disk drives, flash memory devices, optical media, network and virtual storage devices, and the like. As shown, storage 606 contains hand-gesture patterns 133 used as a reference for recognizing hand gestures inputted by the input device 612, hand-gesture numeric mapping rules 134 used as a reference for converting a sequence of inputted hand gestures into a sequence of numeric values, and an index-character dictionary (i.e., an index of characters) used as a reference for looking up characters corresponding to the sequence of numeric values.

As shown, memory 604 stores the hand-gesture recognition daemon 131 that recognizes patterns in inputted hand gestures using the hand gesture patters 133, the hand-gesture numeric converter 132 that converts the recognized patterns/hand gestures into a sequence of numeric values, and the character indexing agent 136 that determines a list of characters matching the inputted hand gestures by searching the index-character dictionary 136 for characters whose index sequence matches the sequence of numeric values. According to certain aspects, list of matching characters may be displayed to the user using the display device 610.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Embodiments of the invention may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud computing resources are provided to a user on a pay-per-use basis, where users are charged only for the computing resources actually used (e.g. an amount of storage space consumed by a user or a number of virtualized systems instantiated by the user). A user can access any of the resources that reside in the cloud at any time, and from anywhere across the Internet. In context of the present invention, a user may access applications (e.g., a hand gesture recognition application) or related data available in the cloud. For example, the hand gesture recognition application could execute on a computing system in the cloud and determine a list of characters (e.g., CJK characters) based on user-inputted hand gestures observed by a wearable computing device. The cloud computing system could determining the list of characters based on one or more of stored hand gesture patterns, hand gesture numeric mapping rules, and/or a index-character dictionary (i.e., an index of characters). The list of characters could then be displayed locally on a user's device. Doing so allows a user to access this information (i.e., the hand gesture recognition application) from any computing system attached to a network connected to the cloud (e.g., the Internet).

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to embodiments of the present invention, other and further embodiments of the invention may be devised without departing from the basic scope thereof, and the scope thereof is determined by the claims that follow.

What is claimed is:

1. A method of generating input for an electronic device corresponding to characters, comprising:
receiving a sequence of hand-gesture inputs from an input device;
detecting a pattern corresponding to each hand-gesture input in the sequence;
determining a sequence of numeric values that correspond to the sequence of hand-gesture inputs based on the detected patterns; and
as each input in the sequence of hand-gesture inputs is received, determining a list of one or more characters to display based, at least in part, on the sequence of numeric values and an index of characters.

2. The method of claim 1, wherein the input device comprises at least one of a camera, a motion sensor, or a bio-electronic sensor.

3. The method of claim 1, wherein the list of one or more characters comprises characters from at least one of a Chinese language, a Japanese language, or a Korean language.

4. The method of claim 1, wherein each character in the index of characters is assigned an index sequence based on a written stroke in each of one or more corners of that character.

5. The method of claim 4, wherein determining the list of one or more characters comprises:
searching the index of characters based on the sequence of numeric values; and
selecting characters to include in the list which have an index sequence that matches the sequence of numeric values.

6. The method of claim 1, wherein the list of one or more characters is refined as each hand-gesture input is added to the sequence of hand-gesture inputs.

7. The method of claim 1, wherein the electronic device comprises a smart-watch or smart-glasses.
